(19) United States
(12) Patent Application Publication
(10) Pub. No.: US 2007/0211073 A1
(43) Pub. Date: Sep. 13, 2007

(54) Compressor, Color Converter, Method Thereof, Program, Look-Up Table, And Storage Medium

(76) Inventor: Masao Sambongi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/547,744

(22) PCT Filed: Apr. 8, 2005
(86) PCT No.: PCT/JP05/07350

§ 371 Date: Oct. 6, 2006

(30) Foreign Application Priority Data
Apr. 9, 2004 (JP) 2004-115623

(51) Int. Cl. G09G 5/02

(52) U.S. Cl. 345/602

(57) ABSTRACT

Color conversion corresponding to input color signals of M kinds (where M is an integer of 2 or greater) is expressed as signal groups, and a principal component analysis is executed to determine a basis signal so that a difference between (1) a value of addition of an average value of the signal groups and a cumulative sum of the basis signal multiplied by a coefficient and (2) the signal groups, becomes a minimum. The coefficient obtained is stored. Employing the stored coefficient, the principal component analysis is executed N times (where 0≦N≦M−2), whereby a compression process for a color conversion process corresponding to each of the input color signals is performed. Thus, a memory quantity is greatly reduced while maintaining accuracy of color conversion of a specified color of LUT to some degree.

### TECHNICAL FIELD

The present invention relates to a compression apparatus, a color converter, a method thereof, a program, a look-up table, and storage medium that are usefully employed in a signal processing system which performs color conversion, employing a color conversion table.

### BACKGROUND ART

As conventional methods of performing color conversion on color signals photographed with a camera, etc., there are a method employing a matrix operation and a method employing a look-up table (hereinafter referred to LUT). General color conversion employing LUT is disclosed, for example, in Patent Document 1. Patent Documents 2 to 5 also disclose the following color conversion and compression techniques.

Patent Document 2 discloses a technique by which an arbitrary compression system such as a Lempel-Ziv (LZ) system is made applicable as an LUT compression system.

Patent Document 3 discloses compression means for data-compressing profile information, compression means for entropy encoding data constituting a profile into a one-dimensional data sequence, and a technique of performing entropy encoding after differential encoding has been performed.

Patent Document 4 discloses a technique of preventing an increase in LUT capacity by employing a one-dimensional LUT which converts luminance information into density information.

Patent Document 5 discloses a technique of compressing data by rearranging data in the order of a direction in which a rate of change in table data is small, and determining a differential value.
[Patent Document 1] Japanese Patent Laid-Open Publication No. Hei 7-107309 (pp. 6-7, FIG. 1)
[Patent Document 2] Japanese Patent Laid-Open Publication No. 2002-64716 (pp. 6 and 8, FIG. 2)
[Patent Document 3] Japanese Patent Laid-Open Publication No. Hei 11-17971 (pp. 5-6, FIG. 4)
[Patent Document 4] Japanese Patent Laid-Open Publication No. 2003-110865 (pp. 9-10, FIG. 1)
[Patent Document 5] Japanese Patent Laid-Open Publication No. 2002-209114 (pp. 10-11, FIG. 1)

However, in the methods employing LUT, if accuracy of color conversion is improved, there is a problem that a memory quantity for LUT will become vast. Thus, the above-described conventional techniques have not realized sufficient compression of a memory quantity.

The present invention has been made in consideration of the problem described above. Accordingly, it is the object of the present invention to provide a compression apparatus, a color converter, a method thereof, a program, a look-up table, and a storage medium which greatly reduce a memory quantity, while maintaining accuracy of color conversion of a specified color of LUT to some degree.

### DISCLOSURE OF THE INVENTION

To soleve the problem described above, a compression apparatus, a color converter, a method thereof, a program, a look-up table, and a storage medium according to the present invention adopt the following features:

(1) A compression apparatus for performing a compression process for a color conversion process corresponding to each of input color signals of M kinds (where M is an integer of 2 or greater), comprising:

a principal component analyzer for executing a principal component analysis which expresses color conversion corresponding to the input color signals as signal groups, and determines a basis signal so that a difference between (1) a value of addition of an average value of the signal groups and a cumulative sum of the basis signal multiplied by a coefficient and (2) the signal groups, becomes a minimum;

a storage unit for storing the coefficient obtained in the principal component analyzer; and

a controller for sending the coefficient stored in the storage unit to the principal component analyzer and causing the principal component analyzer to execute the principal component analysis.

(2) The compression apparatus as set forth in the above (1), wherein the sending of the coefficient to the principal component analyzer by the controller is performed N times (where 0≦N≦M−2).

(3) The compression apparatus as set forth in the above (1) or (2), wherein a look-up table, which performs the color conversion on the basis of the coefficient stored in the storage unit after the execution of the principal component analysis by the controller has been completed, is prescribed.

(4) The compression apparatus as set forth in any of the above (1) to the above (3), further comprising a variable fixer for fixing the other color signal components but one of the input color signals to calculate one-variable signal groups, wherein the principal component analysis is executed on the one-variable signal groups.

(5) The compression apparatus as set forth in any of the above (1) to the above (4), wherein weighting is performed on a specified color signal of the input color signals.

(6) The compression apparatus as set forth in the above (5), wherein a color of the specified color signal is a flesh color, green color, or sky color.

(7) The compression apparatus as set forth in the above (5), wherein a color of the specified color signal is a color whose frequency is greatest by a statistical process performed on an image.

(8) The compression apparatus as set forth in the above (5), wherein a weight of a color whose luminance value is a certain value or less is set smaller than those of other colors.

(9) The compression apparatus as set forth in any of the above (1) to the above (8), wherein the principal component analysis in the principal component analyzer determines the basis signal so that an error of mean square between the addition value and the signal groups becomes a minimum.

(10) The compression apparatus as set forth in any of the above (1) to the above (9), wherein a number of the basis signal in the principal component analysis is arbitrarily determined.

(11) The compression apparatus as set forth in any of the above (1) to the above (10), wherein the coefficient in the principal component analysis is found based on the one-variable signal groups and the basis signal.

(12) The compression apparatus as set forth in any of the above (1) to the above (11), further comprising a converter for converting a color space of the input color signals to a different color space.

(13) The compression apparatus as set forth in any of the above (1) to the above (12), further comprising a weighting signal multiplier for multiplying a predetermined variable of the variable signal groups by a predetermined weighting signal.

(14) A look-up table for outputting signals on the basis of the color conversion corresponding to input signals obtained in the compression apparatus as set forth in the above (1) to the above (13).

(15) A color converter for performing color conversion of input color signals of M kinds (where M is an integer of 2 or greater), comprising:

a principal component analyzer for expressing color conversion corresponding to the input color signals as signal groups, and determining a basis signal so that a difference between (1) a value of addition of an average value of the signal groups and a cumulative sum of the basis signal multiplied by a coefficient and (2) the signal groups, becomes a minimum; and

a color conversion processor for performing the color conversion process on the basis of information obtained in the principal component analyzer.

(16) A color converter for performing color conversion of input color signals of M kinds (where M is an integer of 2 or greater), comprising:

a weighting unit for weighting a specified color signal of the input color signals;

a first principal component analyzer for expressing as first signal groups the input signals in which the specified color signal has been weighted, and determining a first basis signal so that a difference between (1) a value of addition of an average value of the first signal groups and a cumulative sum of the first basis signal multiplied by a first coefficient and (2) the first signal groups, becomes a minimum;

a second principal component analyzer for expressing the input color signals as second signal groups, and determining a second basis signal so that a difference between (1) a value of addition of an average value of the second signal groups and a cumulative sum of the second basis signal multiplied by a second coefficient and (2) the second signal groups, becomes a minimum;

a first color conversion processor for performing a color conversion process on the specified color signal on the basis of information obtained in the first principal component analyzer; and

a second color conversion processor for performing a color conversion process on the color signals other than the specified color signal on the basis of information obtained in the second principal component analyzer.

(17) The color converter as set forth in the above (16) wherein the first color conversion processor and second color conversion processor have a coupler for coupling conversion results of the two color conversion processors at a boundary and its periphery in a color space between a color of the specified color signal and the other colors.

(18) The color converter as set forth in the above (17), wherein the coupler continuously couples the conversion results of the two color conversion processors.

(19) A compression apparatus method for performing a compression process as well as performing a color conversion process corresponding to each of input color signals of M kinds (where M is an integer of 2 or greater), comprising the steps of:

executing a principal component analysis which expresses color conversion corresponding to the input color signals as signal groups, and determines a basis signal so that a difference between (1) a value of addition of an average value of the signal groups and a cumulative sum of the basis signal multiplied by a coefficient and (2) the signal groups, becomes a minimum; and

executing the principal component analysis on the basis of the coefficient.

(20) The compression apparatus method as set forth in the above (19), wherein the sending of the coefficient to the principal component analyzer is performed N times (where 0≦N≦M−2).

(21) The compression apparatus method as set forth in the above (19) or (20), wherein the other color signals but one of the input color signals is fixed to calculate one-variable signal groups, and the principal component analysis is executed on the one-variable signal groups.

(22) The compression apparatus method as set forth in any of the above (19) to the above (21), wherein weighting is performed on a specified color signal of the input color signals.

(23) The compression apparatus method as set forth in the above (22), wherein a color of the specified color signal is a flesh color, green color, or sky color.

(24) The compression apparatus method as set forth in the above (22), wherein a color of the specified color signal is a color whose frequency is greatest by a statistical process performed on an image.

(25) The compression apparatus method as set forth in the above (22), wherein a weight of a color whose luminance value is a certain value or less is set smaller than those of other colors.

(26) The compression apparatus method as set forth in any of the above (19) to the above (25), wherein the principal component analysis determines the basis signal so that an error of mean square between the addition value and the signal groups becomes a minimum.

(27) The compression apparatus method as set forth in any of the above (19) to the above (26), wherein a number of the basis signal in the principal component analysis is arbitrarily determined.

(28) The compression apparatus method as set forth in any of the above (19) to the above (27), wherein the coefficient in the principal component analysis is found based on the one-variable signal groups and the basis signal.

(29) The compression apparatus method as set forth in any of the above (19) to the above (28), wherein a color space of the input color signals is converted to a different color space.

(30) The compression apparatus method as set forth in any of the above (19) to the above (29), wherein a predetermined variable of the variable signal groups is multiplied by a predetermined weighting signal.

(31) A color conversion method of performing color conversion of input color signals of M kinds (where M is an integer of 2 or greater), comprising the steps of:

executing a principal component analysis which expresses color conversion corresponding to the input color signals as signal groups, and determining a basis signal so that a difference between (1) a value of addition of an average value of the signal groups and a cumulative sum of the basis signal multiplied by a coefficient and (2) the signal groups, becomes a minimum; and

performing the color conversion process on the basis of information obtained in the principal component analysis.

(32) A color conversion method of performing color conversion of input color signals of M kinds (where M is an integer of 2 or greater), comprising:

a step of executing a first principal component analysis which weights a specified color signal of the input color signals, expresses as first signal groups the input color signals in which the specified color signal has been weighted, and determines a first basis signal so that a difference between (1) a value of addition of an average value of the first signal groups and a cumulative sum of the first basis signal multiplied by a first coefficient and (2) the first signal groups, becomes a minimum;

a step of executing a second principal component analysis which expresses the input color signals as second signal groups, and determines a second basis signal so that a difference between (1) a value of addition of an average value of the second signal groups and a cumulative sum of the second basis signal multiplied by a second coefficient and (2) the second signal groups, becomes a minimum;

a step of executing a first color conversion process which performs a color conversion process on the specified color signal on the basis of information obtained in the first principal component analysis; and

a step of executing a second color conversion processor which performs a color conversion process on the color signals other than the specified color signal on the basis of information obtained in the second principal component analysis.

(33) The color conversion method as set forth in the above (32), wherein the first color conversion process and second color conversion process have a step of coupling conversion results of the two color conversion processes at a boundary and its periphery in a color space between a color of the specified color signal and the other colors.

(34) The color conversion method as set forth in the above (32), wherein the conversion results of the two color conversion processors are continuously coupled together.

(35) A program for causing a computer to execute the color conversion method as set forth in any of the above (19) to the above (34).

(36) A storage medium with a program which causes a computer to execute the color conversion method as set forth in any of the above (19) to the above (34).

According to the present invention, the following remarkable advantages are obtained. That is, since LUT is compressed, the amount of data is reduced and therefore costs can be made low. A weighting process is performed on a specified color, and employing the weighting principal component analysis, LUT is compressed. Therefore, accuracy in regard to the specified color becomes higher. The number of basis signal after being compressed is changed, and the number of basis can be arbitrarily changed. Therefore, only the required number of basis can be transferred, so that the amount of data is reduced and costs can be made low. Since an input color space for LUT is converted and compressed, compressibility can be increased, or compression can be performed, taking a color difference into consideration. Instead of the weighting principal component analysis, one-variable signal groups are multiplied by a weighting signal, and the principal component analysis is performed on that data. Therefore, processing can be easily performed. An evaluation value is calculated for one-variable signal groups, and a basis signal is found so that the evaluation value is maximized. Therefore, the basis signal can be derived on the basis of the evaluation value. Since an evaluation value is obtained by performing a weighting process on an error of mean square, an error in regard to a specified color can be reduced. The weighting principal component analysis is performed with the above specified color as a flesh color, green, or sky, so stored colors of human beings can be compressed with high accuracy. By performing a statistical process on color information in an image, a color whose frequency is greatest is employed as a specified color. Therefore, the entire image can be compressed with high accuracy. By making smaller the weight of a color whose luminance value is a certain value or less, the accuracy of dark colors not so important to human beings is reduced, whereby the accuracy of bright colors is relatively increased. Since color conversion is performed employing information of LUT compressed, the storage capacity of a ROM becomes small and therefore costs can be made low. By coupling color signals output from two converters, the results of conversion from the two converters can be smoothly joined together. Therefore, colors can also be reproduced without a sense of incompatibility.

### BRIEF DESCRIPTION OF THE DRAWINGS

FIG. 1 is a block diagram showing the configuration of a first embodiment of the present invention;

FIG. 2 is a diagram for explaining a projection on a multidimensional space;

FIG. 3 is a diagram for explaining weighting in the embodiment of the present invention;

FIG. 4 is a block diagram showing the configuration of a second embodiment of the present invention;

FIG. 5 is a diagram for explaining a second method of the weighting principal component analysis of the present invention;

FIG. 6 is a diagram for explaining a third method of the weighting principal component analysis of the present invention;

FIG. 7 is a flowchart in regard to software processes by which processes in the first embodiment shown in FIG. 1 are executed;

FIG. 8 shows another embodiment of the present invention and is a diagram showing the configuration of a system which color-converts and outputs image data photographed with a digital camera;

FIG. 9 is a block diagram showing a configuration of the color converter 300 in FIG. 8;

FIG. 10 shows still another embodiment of the present invention and is a diagram showing the configuration of a system which color-converts and outputs image data photographed with a digital camera;

FIG. 11 is a block diagram showing a configuration of the color converter 300A shown in FIG. 10;

FIG. 12 is a block diagram showing the configuration of the processors 300B in the embodiment shown in FIG. 8;

FIG. 13 is a diagram for explaining the region of a color space in the embodiments of the present invention;

FIG. 14 is a diagram for explaining a weight coefficient in the embodiments of the present invention; and

FIG. 15 is a flowchart showing processing procedures that are carried out by the second embodiment shown in FIG. 8.

### BEST MODE FOR CARRYING OUT THE INVENTION

The configuration and operation of a preferred embodiment of a compression apparatus, a color converter, a method thereof, a program, a look-up table (LUT), and a storage medium according to the present invention will hereinafter be described in detail with reference to the accompanying drawings.

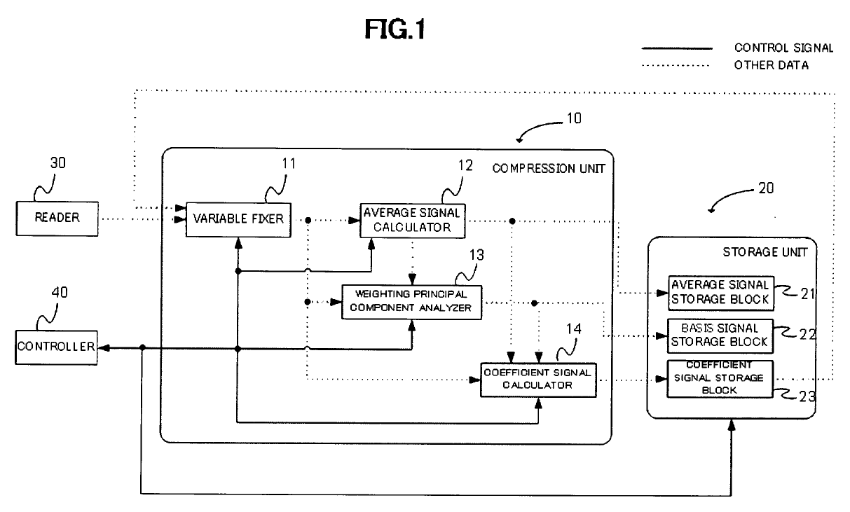

FIG. 1 is a block diagram showing the configuration of a first embodiment of the present invention. In the following block diagram, a thick line indicates an image signal, a thin line indicates a control signal, and a dashed line indicates the other data.

For LUT read by a reader 30, a variable fixer 11, under control of a controller 40, fixes the other variables but one variable of input color signals to calculate one-variable signal groups. An average signal calculator 12, under control of the controller 40, calculates an average of the signal groups transferred from the variable fixer 11. The calculated average signal is transferred to an average signal storage block 21 of a storage unit 20.

A weighting principal component analyzer 13, in accordance with processing to be described later, performs a weighting principal component analysis on the signal groups transferred from the variable fixer 11 to determine a basis signal, under control of the controller 40. The found basis signal is stored in a basis signal storage block 22 of the storage unit 20.

A coefficient signal calculator 14, under control of the controller 40, calculates a coefficient signal, employing the signal groups transferred from the variable fixer 11, the average signal transferred from the average signal calculator 12, and the basis signal transferred from the weighting principal component analyzer 13. The calculated coefficient signal is transferred to a coefficient signal storage block 23 of the storage unit 20. Under control of the controller 40, the coefficient signal stored in the coefficient signal storage block 23 of the storage unit 20 is transferred to the variable fixer 11 to repeat the above-described processing.

The operation and logical grounds of the above configuration will hereinafter be described in detail.

Initially, assume that LUT is a table which performs conversion from red, green, and blue (rgb) signals to L*, a*, and b* (L*a*b*) signals. Color conversion employing LUT is considered as a signal such as the following Eq. 1:
f(r,g,b)=u u=(L*,a*,b*) (1)
in which f(r, g, b) represents vector signals of red, green, and blue (rgb) signals which are input color signals, and the elements of u(L*, a*, b*) represent vectors of L*, a*, and b* (L*a*b*) signals which are output color signals. If it is assumed that rgb signals are Nᵣ discrete values, N_{g} discrete values, and N_{b} discrete values, L*a*b* signals are Nᵣ×N_{g}×N_{b} output values. If the elements of Eq. 1 are expressed in the form of a matrix, the following Eq. 2 is obtained:

$$[ \begin{matrix}{f}_{{L}^{*}} ( r , g , b ) \\ {f}_{{a}^{*}} ( r , g , b ) \\ {f}_{{b}^{*}} ( r , g , b )\end{matrix} ] = [ \begin{matrix}{L}^{*} \\ {a}^{*} \\ {b}^{*}\end{matrix} ] \qquad ( 2 )$$

in which f_{L*}(r, g, b), f_{a*}(r, g, b), and f_{b*}(r, g, b) represent signals with respect to L*a*b* signals, respectively. In this example, although the rgb and L*a*b* signals are described, any color signals maybe employed. For instance, input color signals may be Y, Cb, and Cr (YCbCr) signals and output color signals may employ L*, u*, and V* (L*u*v*) signals. In addition, they may be reversed. In the following description, fᵢ(r, g, b) (i=L*, a*, b*) is employed as f(r, g, b) generalized by omitting the subscript i.

First, f(r, g, b) is calculated as a one-variable signal by fixing two arbitrary variables, using the variable fixer 11. For example, when two variables r and g are fixed, f(r, g, b) is expressed as f_{r,g}(b) and considered as a signal of “b” with respect to the two variables r and g. Next, employing the weighting principal component analyzer 13, a weighting principal component analysis is performed on signal groups expressed in terms of f_{r,g}(b) to determine a basis signal. This basis signal is transferred to the coefficient signal calculator 14.

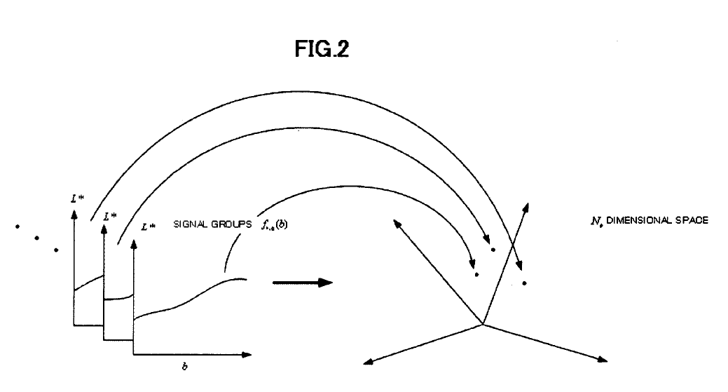

Next, the concepts of the principal component analysis and weighting principal component analysis will be described. The elements b of the signal groups f_{r,g}(b) are N_{b} discrete values, and the signal groups f_{r,g}(b) are considered as vectors in an N_{b}-dimensional space such as that shown in FIG. 2. Since signal groups are present by the number of values that red and green (rg) signals can have, the number of signal groups in this case is Nᵣ×N_{g}. The principal component analysis makes a conversion of axes (i.e., basis) in the N_{b}-dimensional space besed on the statistical nature of data. The use of the idea of the principal component analysis can approximate f_{r,g}(b) in a few number of basis.

The principal component analysis is a method of analysis which employs an error of mean square between signal groups and approximated signal groups as an evaluation value and determines a basis signal so that the evaluation value is minimized. However, when it is desired that an error in regard to only a specified color is made smaller, the above-described principal component analysis method is insufficient. Hence, by employing a weighting evaluation value which makes the contribution of a specified-color error to an error of mean square greater, the above-described problem can be overcome.

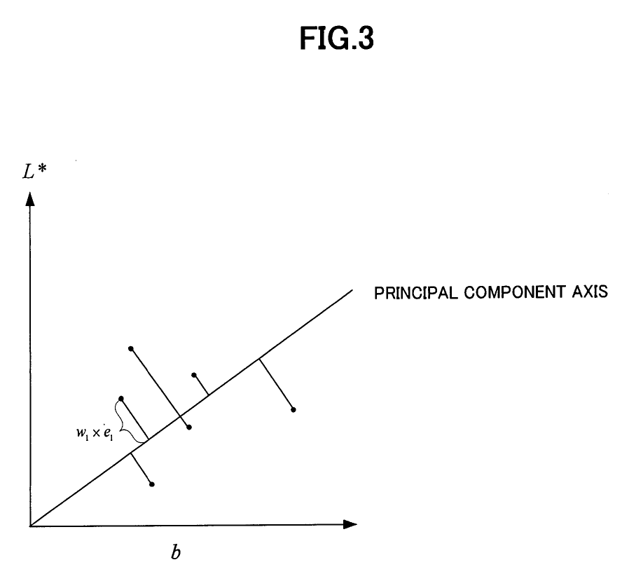

In FIG. 3, if signal groups are expressed as points in two dimensions, an error between signal groups approximated on the principal component axis and the original signal groups is expressed in a straight line such as el. Weighting used herein means that the error is multiplied by a weight (w₁×e₁).

Next, since a coefficient signal is a signal of “rg”, the coefficient signal is considered as vectors in a multidimensional space, as with the above-described method. Therefore, the weighting principal component analysis is performed to determine basis signals of the coefficient signal. The number of data of LUT for a certain output signal (e.g., an output signal L*) is Nᵣ×N_{g}×N_{b}. However, if basis signals are found by the method described above, and n basis are employed for signal groups and m basis signals are employed for the coefficient signal, the number of data can be reduced to Nᵣ×m×n. Depending on how many basis signals are employed, an error relative to the original LUT varies. The number of basis signals can be arbitrarily determined. However, how much the basis signals represent information is determined by the magnitude of an eigenvalue calculated in performing the weighting principal component analysis described above. Therefore, the number of basis signals may be determined by the value of this eigenvalue.

In this example, while compression is started from a signal f_{r,g}(b) in which r and g are fixed, compression may be started, for example, by employing a signal f_{r,b}(g) in which r and b are fixed. Even in this case, a compression process can be performed in the same manner as the method described above. In the above case, a coefficient signal in the coefficient storage block 23 is retransferred once to the compression apparatus 10, but the number of retransfers is N times when input color signals of M kinds (where 0≦N≦M−2) are input. For example, in the case of input color signals of three kinds, the number of retransfers is either zero or once. In addition, even in the case where a plurality of LUTS, for example, LUT1 and LUT2 are present, signal groups f¹_{r,g}(b) and f²_{r,g}(b) corresponding to the respective LUTs are found in exactly the same manner as the method described above, and these signal groups can be compressed together, employing the principal component analysis. Of course, any number of LUTs may be employed.

More specifically, the vectors expressed in FIG. 2 are expressed in terms of f_{r,g}=[f_{r,g} (b₁), f_{r,g} (b₂), . . . , f_{r,g} (b_{Nb})]^{t}. []^{t} represents the transposition of a vector or matrix. Because signals f_{r,g} are present by the number of values that r and g signals can have, in this case Nᵣ×N_{g} signals f_{r,g} are present.

To compress the amount of information of the signal groups, reducing the number of dimensions of f_{r,g} is considered. If the signal groups f_{r,g} are approximated in terms of n (n≦Nb) basis signals eᵢ (i=1 to n), the approximated signal groups are expressed by the following Eq. 3:

$${\hat{f}}_{r , g} = {\overline{f}}_{r , g} + {\sum }_{i = 1}^{n} {a}_{r , g , i} {e}_{i} \qquad ( 3 )$$

in which

$${\overline{f}}_{r , g} = \frac{1}{{N}_{r} {N}_{g}} {\sum }_{r , g} {f}_{r , g} \qquad ( 5 )$$

Equation (5) represents an average of the signal groups f_{r,g}.

The principal component analysis is performed by determining a basis signal eᵢ so that the following evaluation value becomes a minimum.

$$J = {\sum }_{r , g} {‖ ( {\overline{f}}_{r , g} + {\sum }_{i = 1}^{n} {a}_{r , g , i} {e}_{i} ) - {f}_{r , g} ‖}^{2} \qquad ( 6 )$$

in which the symbol ∥ ∥ represents a norm. Although details are not given, it is known that the basis signal eᵢ minimizing Eq. 6 is the eigenvector of the following scattering matrix S:

$$S = {\sum }_{r , g} ( {f}_{r , g} - {\overline{f}}_{r , g} ) {( {f}_{r , g} - {\overline{f}}_{r , g} )}^{t} \qquad ( 7 )$$

That is to say,
Seᵢ=λᵢeᵢ (8)
in which λᵢ is an eigenvector, that is, an eigenvalue relative to the basis signal eᵢ. From Eq. 4, the use of the idea of the principal component analysis is able to express the signal groups f_{r,g} in a few number of dimensions n.

The idea of the above-mentioned principal component analysis, as apparent from Eq. 6, is to determine the basis signal eᵢ which approximates the signal groups f_{r,g} so that an error of means square becomes a minimum. However, when an error in regard to only a specified color is made smaller and errors in regard to the other colors are not so taken into consideration, the evaluation signal of Eq. 6 is insufficient. Hence, the following weighting matrix W which is a diagonal matrix is considered.

$$W = [ \begin{matrix}{w}_{1} & 0 & 0 & 0 \\ 0 & {w}_{2} & 0 & 0 \\ 0 & 0 & ⋰ & ⋮ \\ 0 & 0 & ⋯ & {w}_{n}\end{matrix} ] \qquad ( 9 )$$

When wᵢ=1 (i=1, 2, . . . , n), all become equal weights, so that the weighting matrix W is the same as a normal principal component analysis.

In addition, when a desired specified color is in the range of bₗ, (BL) to bₒ, (BO) of a “b” signal, if a range of wₗ (WL) to wₒ (WO) is one and the other ranges are zero, the weighting matrix W is equivalent to a principal component analysis which minimizes a square error between the original LUT and compressed LUT only in a range of a specified color. The subscripts “l” and “o” are arbitrary values between 1 and n, and the subscript “l” is less than or equal to the subscript “o” (l≦o). If the value of wᵢ is arbitrarily set in the range of 0 (zero) to 1 (one), the weighting matrix W becomes a principal component analysis which is able to control a square error between a specified color and other colors. In this example, the value of wᵢ is limited to 0 to 1. However, wᵢ is not to be limited to this range, but maybe any value. By employing this weighting matrix, it becomes possible to give a weight to an arbitrary element of multidimensional data.

The evaluation signal is found by employing this weighting matrix W. For simplicity, the signal groups f_{r,g} are approximated by one basis signal e₁. That is to say, the signal groups f_{r,g} are approximated by the following Eq. 10:
\hat{f}_{r,g}= f̅_{r,g}+α_{r,g}e₁ (10)
From Eq. 6, the evaluation signal employing the weighting matrix W is given as:

$${J}_{w} = {\sum }_{r , g} {\{ ( {\overline{f}}_{r , g} + {a}_{r , g} {e}_{1} ) - {f}_{r , g} \}}^{t} W \{ ( {\overline{f}}_{r , g} + {a}_{r , g} {e}_{1} ) - {f}_{r , g} \} \qquad ( 11 )$$

Differentiating both sides of Eq. 11 by a_{r,g} gives

$$\begin{matrix}\frac{\partial {J}_{w}}{\partial {a}_{r , g}} = 2 {e}_{1}^{t} W \{ {\overline{f}}_{r , g} + {a}_{r , g} {e}_{1} - {f}_{r , g} \} = 0 & ( 12 ) \\ {a}_{r , g} = {C}_{1} {e}_{1}^{t} W ( {f}_{r , g} - {\overline{f}}_{r , g} ) & ( 13 )\end{matrix}$$

in which C₁=(e₁^{t}We₁)⁻¹. Next, an optimum basis signal eᵢ is found.

Transforming Eq. 11 gives

$$\begin{matrix}{J}_{w} = {\sum }_{r , g} {\{ {a}_{r , g} {e}_{1} - ( {f}_{r , g} - {\overline{f}}_{r , g} ) \}}^{t} W \{ {a}_{r , g} {e}_{1} - ( {f}_{r , g} - {\overline{f}}_{r , g} ) \} \\ = {\sum }_{r , g} {a}_{ r , g}^{ 2} {e}_{ 1}^{ t} {We}_{ 1} - 2 {\sum }_{r , g} { {a}_{ r , g} ( {f}_{ r , g} - { {f}^{ \_}}_{ r , g} )}^{t} {We}_{ 1} + \\ {\sum }_{r , g} {( {f}_{ r , g} - { {f}^{ \_}}_{ r , g} )}^{t} W ( {f}_{ r , g} - { {f}^{ \_}}_{ r , g} )\end{matrix} \qquad \begin{matrix}( 14 ) \\ \\ ( 15 )\end{matrix}$$

Now, substituting a_{r,g} of Eq. 13 into Eq. 14 gives

$$\begin{matrix}{J}_{w} = {C}_{1} {\sum }_{r , g} {e}_{1}^{t} W ( {f}_{r , g} - {\overline{f}}_{r , g} ) {( {f}_{r , g} - {\overline{f}}_{r , g} )}^{t} {We}_{1} {e}_{1}^{t} {We}_{1} - \\ 2 {C}_{1} {\sum }_{r , g} {e}_{1}^{t} W ( {f}_{r , g} - {\overline{f}}_{r , g} ) {( {f}_{r , g} - {\overline{f}}_{r , g} )}^{t} {We}_{1} + \\ {\sum }_{r , g} {( {f}_{r , g} - {\overline{f}}_{r , g} )}^{t} W ( {f}_{r , g} - {\overline{f}}_{r , g} ) \\ = {C}_{1}^{2} {e}_{1}^{t} {WSWe}_{1} - 2 {C}_{1} {e}_{1}^{t} {WSWe}_{1} + {\sum }_{r , g} {( {f}_{r , g} - {\overline{f}}_{r , g} )}^{t} W ( {f}_{r , g} - {\overline{f}}_{r , g} ) \\ = ( {C}_{1}^{2} - 2 {C}_{1} ) {e}_{1}^{t} {WSWe}_{1} + {\sum }_{r , g} {( {f}_{r , g} - {\overline{f}}_{r , g} )}^{t} W ( {f}_{r , g} - {\overline{f}}_{r , g} )\end{matrix} \qquad \begin{matrix}( 16 ) \\ \\ \\ \\ \\ \\ ( 17 ) \\ \\ ( 18 ) \\ \end{matrix}$$

By selecting e₁ so that e₁^{t}We₁=1, Eq. 14 becomes

$${J}_{w} = - {e}_{1}^{t} {WSWe}_{1} + {\sum }_{r , g} {( {f}_{r , g} - {\overline{f}}_{r , g} )}^{t} W ( {f}_{r , g} - {\overline{f}}_{r , g} ) \qquad ( 19 )$$

To minimize J_{w}, e₁^{t}WSWe₁ may be maximized. With e₁^{t}We₁=1, in order to maximize e₁^{t}WSWe₁, by Lagrange's method of undetermined multipliers, “u” is set to
u=e₁^{t}WSWe₁−λ(e₁^{t}We₁−1) (20)
Differentiating “u” by e₁ gives

$$\begin{matrix}\frac{\partial u}{\partial {e}_{1}} = 2 {WSWe}_{1} - 2 λ {We}_{1} = 0 & ( 21 ) \\ {WSWe}_{1} = λ {We}_{1} & ( 22 )\end{matrix}$$

It is easily understood that this is the form of an eigenvalue problem.

Therefore, by employing Eq. 22, it becomes possible to determine an optimum basis signal e₁. It is also possible to determine other basis signals in the same manner by the following Eq. 23:
WSWeᵢ=λᵢWeᵢ (23)

Based on the above concept, the weighting principal component analysis is performed. According to the flow of signals in FIG. 1, the following Eq. 24 is calculated by the average signal calculator 12 and is transferred to the average signal storage block 21.

$${\overline{f}}_{r , g} = \frac{1}{{N}_{r} {N}_{g}} {\sum }_{r , g} {f}_{r , g} \qquad ( 24 )$$

Employing n(n≦Nb) basis signals eᵢ, f_{r, g}, that is, f(r, g, b) is approximated as follows:

$${\hat{f}}_{r , g} = \hat{f} ( r , g , b ) = {\sum }_{i = 1}^{n} {a}_{i} ( r , g ) {e}_{i} + {\overline{f}}_{r , g} = {Ea}^{t} ( r , g ) + {\overline{f}}_{r , g} \qquad ( 25 )$$

in which a(r,g)=[a₁(r,g), . . . , aₙ(r,g)] represents an expansion coefficient, and E=[e₁, . . . , eₙ] is the basis signal. The basis signal E=[e₁, . . . , eₙ] is transferred to the basis signal storage block 22. By the coefficient signal calculator 14, the expansion coefficient a(r,g) is calculated as follows:
a(r,g)=(\hat{f}_{r,g}− f̅_{r,g})^{t}WE (26)
The expansion coefficient a(r,g) is transferred to the coefficient signal storage block 23.

Next, this expansion coefficient a(r,g) is transferred to the variable fixer 11, and is compressed. Employing the variable fixer 11, “r” in the expansion coefficient a(r,g) is fixed, whereby the expansion coefficient a(r,g) is considered as a signal of “g” which is aᵣ(g)=[a_{1,r}(g), a_{2,r}(g), . . . , a_{n,r}(g)]. Next, let Aᵣ=[a_{1,r}, a_{2,r}, . . . , a_{n,r}], and a_{i,r}=[a_{i,r}(g₁), a_{i,r}(g₂), . . . , a_{i,r}(g_{ng)]}^{t} (where i=1, 2, . . . , n). At this stage, a_{i,r} consists of n×Nᵣ values.

Similarly, for the efficient a_{1,r}, as shown in FIG. 2, a_{1,r} is considered to be vectors in a multidimensional space, and the weighting principal component analysis is performed to determine a basis signal dⱼ=[dⱼ(g₁), dⱼ(g₂), . . . , dⱼ(g_{ng})]^{t} (where j=1, 2, . . . , ng).

Approximating a_{1,r} by m (m≦N_{g}) basis signals gives

$${\hat{a}}_{i , r} = {\sum }_{j = 1}^{m} {b}_{i , j} ( r ) {d}_{j} + {\overline{a}}_{i , r} = {Db}_{i}^{t} ( r ) + {\overline{a}}_{i , r} \qquad ( 27 )$$

in which

$${\hat{a}}_{i , r} = {\sum }_{j = 1}^{m} {b}_{i , j} ( r ) {d}_{j} + {\overline{a}}_{i , r} = {Db}_{i}^{t} ( r ) + {\overline{a}}_{i , r} \qquad ( 28 )$$

approximates a_{l,r},

$${\overline{a}}_{i , r} = \frac{1}{{nN}_{r}} {\sum }_{i , r} {a}_{i , r} \qquad ( 29 )$$

is calculated by the average signal calculator 12, bᵢ(r)=[b_{i,1}(r), b_{i,2}(r), . . . , b_{i,m}(r)] is an expansion coefficient calculated by the coefficient signal calculator 14, and D=[d₁, d₂, . . . , dₘ] is a basis signal.

$${\overline{a}}_{i , r} = \frac{1}{{nN}_{r}} {\sum }_{i , r} {a}_{i , r} \qquad ( 30 )$$

is transferred to the average signal storage block 21, bᵢ(r) is transferred to the coefficient signal storage block 23, and D is transferred to the basis signal storage block 22.

Employing Eq. 27, a coefficient matrix Ar can be expressed as
Aᵣ′=[b₁(r)D′+ a̅_{i,r},b₂(r)D′+ a̅_{i,r}, . . . , bₙ(r)D′+ a̅_{i,r}] (31)

f′(r, g, b) which approximates f(r, g, b) finally can be expressed as
f′(r,g,b,)=EAᵣ′^{t}30 f̅_{r,g} (32)

The number of data in LUT for a certain output signal (for example, an output signal L*) is Nᵣ×N_{g}×N_{b}, but by performing the principal component analysis described above, the number of data can be compressed to Nᵣ×m×n. Depending on what number “m” and “n” have, that is, how many basis signals are employed, an error in regard to the original LUT varies. The number of basis signals can be arbitrarily determined. However, for example, how much the basis signals represent the original information is determined by the magnitude of the eigenvalue λᵢ in Eq. 23, so the number of basis signals may be determined by the value of this eigenvalue.

In this example, compression is started from the signal f_{r,g}(b) in which r and g are fixed. However, employing, for example, the signal f_{r,b}(g) in which r and b are fixed, compression may be started, and the compression process can be performed in the same manner as the method described above. In the above case, a coefficient signal in the coefficient storage block 23 is retransferred once to the compression apparatus 10, but the number of retransfers is N times when input color signals of M kinds (where 0≦N≦M−2) are input. For instance, in the case of input color signals of three kinds, the number of retransfers is either zero or once.

In addition, even in the case where a plurality of LUTS, for example, LUT1 and LUT2 are present, signal groups f¹_{r,g}(b) and f²_{r,g}(b) corresponding to the respective LUTs are found in exactly the same manner as the method described above, and these signal groups can be compressed together, employing the principal component analysis. It is a matter of course that any number of LUTs may be employed.

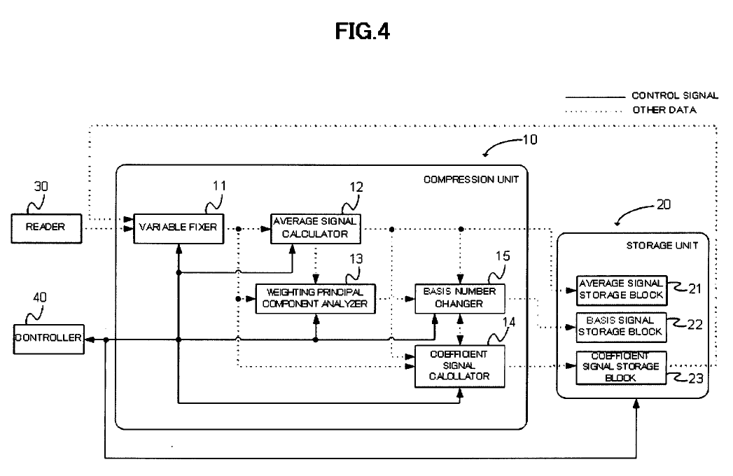

FIG. 4 is a block diagram showing the configuration of a second embodiment of the present invention. In the figure, parts given the same reference numerals as FIG. 1 indicate parts having the same functions.

Referring to FIG. 4, a compression apparatus in this embodiment is equipped with a variable fixer 11, an average signal calculator 12, a weighting principal component analyzer 13, a coefficient signal calculator 14, and a basis number changer 15, and differs in that the basis number changer 15 is added to the configuration of FIG. 1.

The basis number changer 15, under control of a controller 40, arbitrarily changes the number of basis of the basis signal transferred from the weighting principal component analyzer 13. The number of basis may be determined by users, or from the value of an eigenvalue.

By employing the configuration of an embodiment such as that shown in FIG. 4, the number of basis can be arbitrarily changed, and since only the required number of basis can be transferred, the amount of data can be reduced and therefore costs can be made low.

By adopting the configuration described above, it becomes possible to compress LUT, whereby the storage capacity of a ROM is reduced and therefore costs can be made low. In addition, by performing a weighting process on a desired specified color, an error in regard to the specified color can be reduced, so that effective compression can be performed. The specified color may be a color such as a flesh color, sky, or green. By statistically classifying histograms of color information in an image, a color which appears with frequency greater than a threshold value maybe employed as the specified color described above. By reducing the weight of a color whose luminance value is a certain value or less, an error in regard to a color whose luminance value is high is relatively reduced, so that effective compression becomes possible. Because compression is performed employing the principal component analysis, effective compression can be performed according to data. Since the number of basis can be changed according to a color difference, the number of basis can be changed in accordance with use purposes, so it becomes possible to perform an effective compression process.

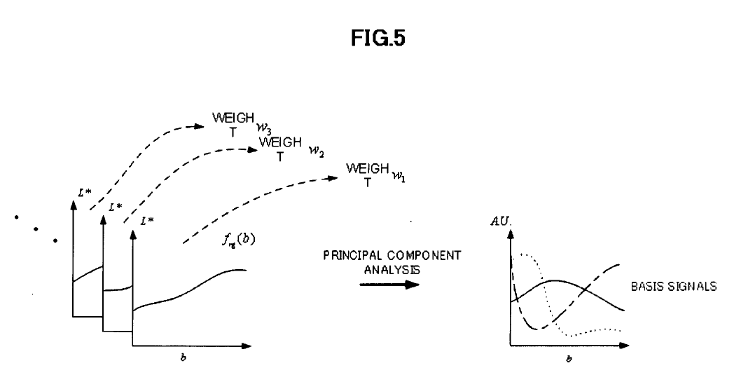

FIG. 5 is a diagram for explaining a second method of the weighting principal component analysis, which is a method of weighting each data. That is, the principal component analysis is performed by weighting each of the signal groups. This process has the same advantages as the case of weighting a color space of r and g signals.

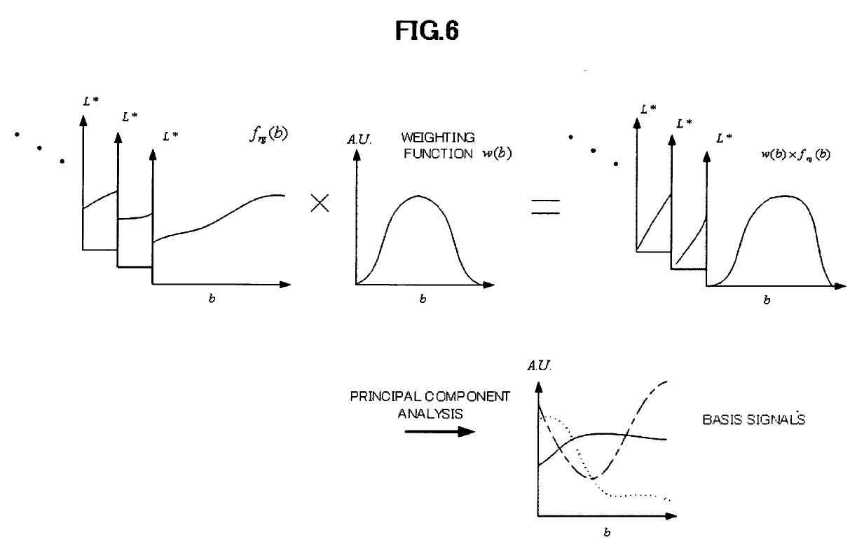

FIG. 6 is a diagram for explaining a third method of the weighting principal component analysis. By multiplying signal groups f_{r,g}(b) by a weighting signal w(b), the principal component analysis is performed. Since this process performs a normal principal component analysis on signal groups multiplied by a weighting signal, the process can be easily performed.

In addition, by converting input color signals of LUT when performing compression in the method described above, effective compression can be performed. For example, by arranging before the reader 30 a converter which converts color signals of LUT from rgb signals to YCbCr signals, and transferring to the reader 30 the LUT in which input color signals have been converted, compression can be performed, taking a color difference into consideration.

The above embodiment is based on processing by hardware, but the present invention does not need to be limited to such a configuration. For example, it is a matter of course that a configuration which performs processing by separate software is also possible.

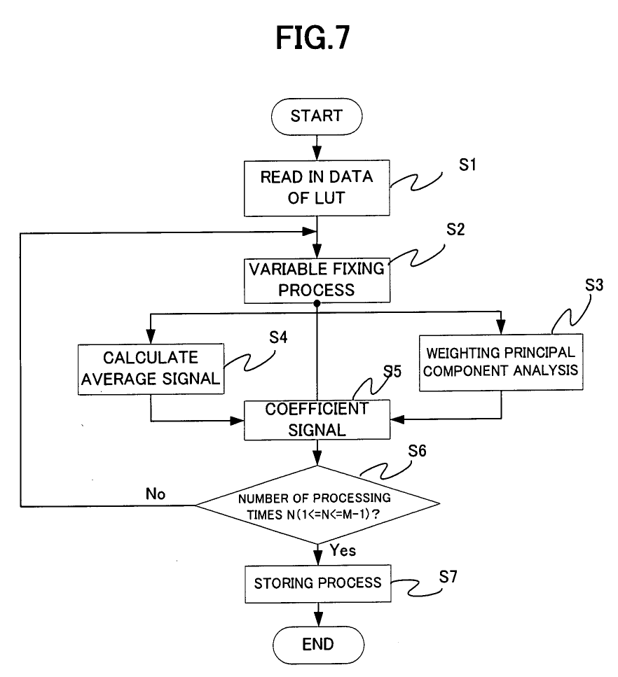

In FIG. 7, a flowchart of processing procedures corresponding to the first embodiment of FIG. 1 is shown.

Referring to FIG. 7, in step S1 data of LUT are read in, and in step S2, a variable fixing process of fixing the other variables but one variable of LUT, corresponding to the variable fixer 11 of FIG. 1, is performed. Subsequently, in step S3, a weighting principal component analysis corresponding to the weighting principal component analysis of FIG. 1 is performed. Next, in step S4, an average signal corresponding to the average signal calculator 12 of FIG. 1 is calculated, and in step S5, a coefficient signal corresponding to the coefficient signal calculator 14 of FIG. 1 is calculated, employing the results obtained in steps S3 and S4. In step S6, it is judged whether the number of times that processing is performed is N times, and when it is less than N times, a coefficient signal for carrying out step S2 is transferred and processing is performed again. When the number of times is N times, in step S7 the calculated average signal, basis signal, and coefficient signal are stored and the processing is ended.

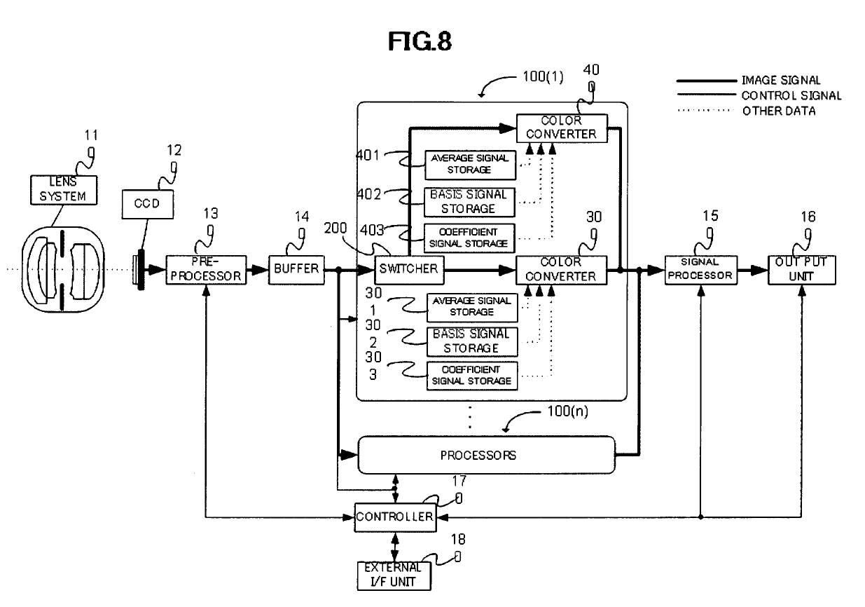

Next, another embodiment of the present invention will be described with reference to FIG. 8. This embodiment is applied to an output system that color-converts image data photographed with a digital camera.

Referring to FIG. 8, an image photographed through a lens system 100 and a CCD 120 is converted into a digital signal via a preprocessor 130 that performs processing such as gain amplification, A/D conversion, AF control, AE control, etc.

The digital signal processed in the preprocessor 130 is stored in a buffer 140. Data read out from the butter 140 is color-converted and input to a plurality of processors 100(1), . . . , and 100(n) each having the same configuration. For example, data read out from the buffer 140 is input to a switcher 200 of the processor 100(1).

The switcher 200 switches and outputs the data read out from the buffer 140, to a color converter 300 and a color converter 400. The color converter 300 includes average signal storage 301, basis signal storage 302, and a coefficient signal storage 303, while the color converter 400 includes an average signal storage 401, a basis signal storage 402, and a coefficient signal storage 403.

The data color-converted in the color converter 300 and color converter 400 is sent to a signal processor 150 that performs processing such as edge enhancement, gamut mapping, etc.

The data given the above processing by the signal processor 150 is output to an output unit 160 such as a memory card, etc.

The number of processors 100(1), . . . , and 100(n) changes, depending on the kinds of color signals being output. For instance, in the case where output signals are L*, a*, and b* signals, the number of processors is 3.

In the example shown in FIG. 8, n kinds of color signals are output. A controller 170, which is made up of a microcomputer, etc., functions to control an overall operation and is connected in two directions to the preprocessor 130, processors 100(1), . . . , and 100(n), signal processor 150, and output unit 160. An external I/F unit 180, equipped with a power switch, a shutter button, and an interface for switching various modes at the time of photography, is also connected in two directions to the controller 170.

The signal flow in the configuration shown in FIG. 8 will be described. After photography conditions such as ISO sensitivity have been set through the external I/F unit 180, an image signal is taken in by pushing the shutter button. The image signal photographed through the lens system 110 and CCD 120 is transferred to the buffer 140 via the preprocessor 130 that performs gain amplification, A/D conversion, AF control, AE control, etc. It is a matter of course that signals to be transferred to the buffer are not only “rgb” signals but also may be “YCbCr” signals and other signals.

A color signal readout from the buffer 140 is transferred, for example, to the switcher 200 of the processor 100(1). When the color signal is contained in the predetermined range of a specified color, the switcher 200 transfers the color signal to the color converter 300.

The color converter 300 contained in the processor 100(1) performs a color conversion process under control of the controller 170, employing information stored in the average signal storage 301, basis signal storage 302, and coefficient signal storage 303. The color converter 400 contained in the processor 100(1) performs a color conversion process under control of the controller 170, employing information stored in the average signal storage 401, basis signal storage 402, and coefficient signal storage 403. The average signal storage 301, basis signal storage 302, and coefficient signal storage 303 perform a weighting process on a specified color of LUT and store information obtained when the principal component analysis is performed. On the other hand, the average signal storage 401, basis signal storage 402, and coefficient signal storage 403 store information obtained when a normal principal component analysis is performed. The color converter 300 and color converter 400 each perform a color conversion process on the image signal, and the results are transferred to the signal processor 150.

In the case of output color signals of n kinds, the number of processors containing the color converter 300 and color converter 400 is n. The signal processor 150 performs processing such as edge enhancement, gamut mapping, etc., under control of the controller 170. A signal after being processed is transferred to the output unit 160. The processing in the processor 100(1) and processing in the processor 100(n) are executed in synchronization under control of the controller 170.

That is to say, in this embodiment, processing is performed in predetermined region units, and image signals after being color-converted are sequentially transferred to the output unit 160. The output unit 160 sequentially records and stores the transferred image signals on a memory card, etc.

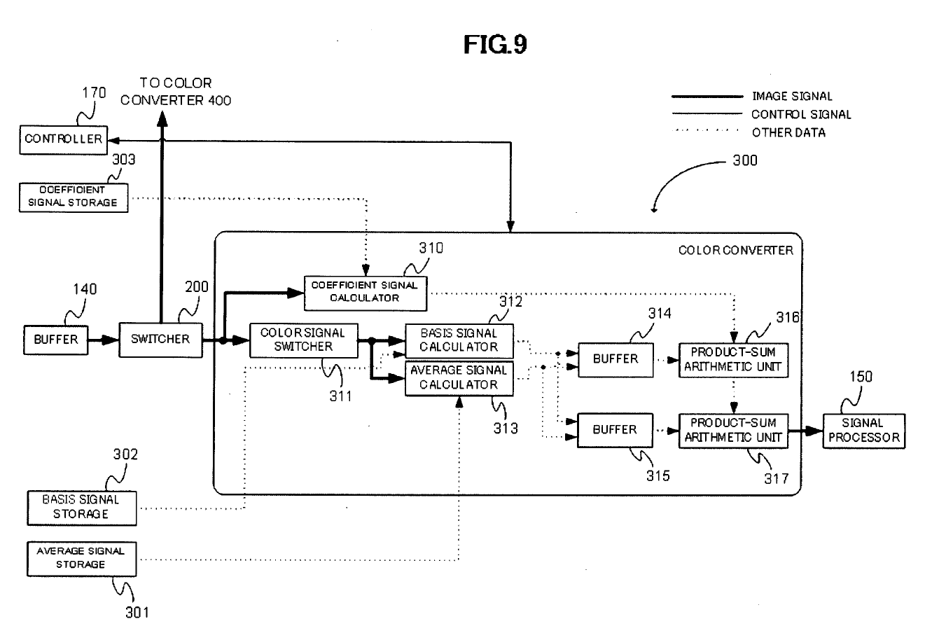

FIG. 9 is a block diagram showing a configuration of the color converter 300 in FIG. 8. The color converter 300 comprises a coefficient signal calculator 310, a color signal switcher 311, a basis signal calculator 312, an average signal calculator 313, a buffer 314, a buffer 315, a product-sum arithmetic unit 316, and a product-sum arithmetic unit 317. The configuration of the color converter 400 is the same the color converter 300, so it is not shown.

The coefficient signal calculator 310, under control of the controller 170, calculates a coefficient signal on the basis of a signal transferred from the coefficient signal storage 303 and an “r” signal transferred through the switcher 200, and outputs it to the product-sum arithmetic unit 316. A “g” signal and a “b” signal transferred through the switcher 200 are transferred to the color signal switcher 311, and one signal, for example, the “g” signal is transferred to the basis signal calculator 312 and the average signal calculator 313.

The basis signal calculator 312 calculates a basis signal on the basis of a signal transferred from the vase signal storage 302 and a signal transferred from the color signal switcher 311. The average signal calculator 313 calculates an average signal on the basis of a signal transferred from the average signal storage 301 and a signal transferred through the color signal switcher 311. The calculated basis signal and average signal are transferred to the buffer 314, and are stored.

The product-sum arithmetic unit 316 performs a product-sum arithmetic process, employing signals transferred from the coefficient signal calculator 310 and buffer 314, and transfers the results to the product-sum arithmetic unit 317. This processing corresponds to processing by the aforementioned Eq. 27.

Next, the color signal switcher 311 transfers the other signal, e.g., the “b” signal to the basis signal calculator 312 and the average signal calculator 313. The basis signal calculator 312 and the average signal calculator 313 similarly calculate a basis signal and an average signal and transfer them to the buffer 315. The product-sum arithmetic unit 317 likewise performs a product-sum arithmetic process, employing signals transferred from the buffer 315 and product-sum arithmetic unit 316, and transfers the results to the signal processor 150.

The color signals that are contained in the buffer 140 are red, green, and blue (rgb), but may be other signals, Y, Cb, and Cr signals. In addition, the signal that is transferred to the coefficient signal calculator 310 may be any kind of signal, for example, a “g” signal or “b” signal. Likewise, the color signal that is transferred to the color switcher 311 may be any kind of signal. In this case, two kinds of color signals are transferred to the color signal switcher 311, but color signals to be transferred may be any kinds. For instance, in the case where three kinds of color signals are transferred to the color signal switcher 311, three buffers 314 and three product-sum arithmetic units 316 are employed. The color converter described above is provided for one output value, and in the case where output values are three kinds, L*, a*, and b*, three processors are required.

The number of average signals stored in the average signal storage 301 needs to correspond to the number of basis signals stored in the basis signal storage 302. When a compression process is performed once, one average signal is stored in the average signal storage 301 and one basis signal is stored in the basis signal storage 302.

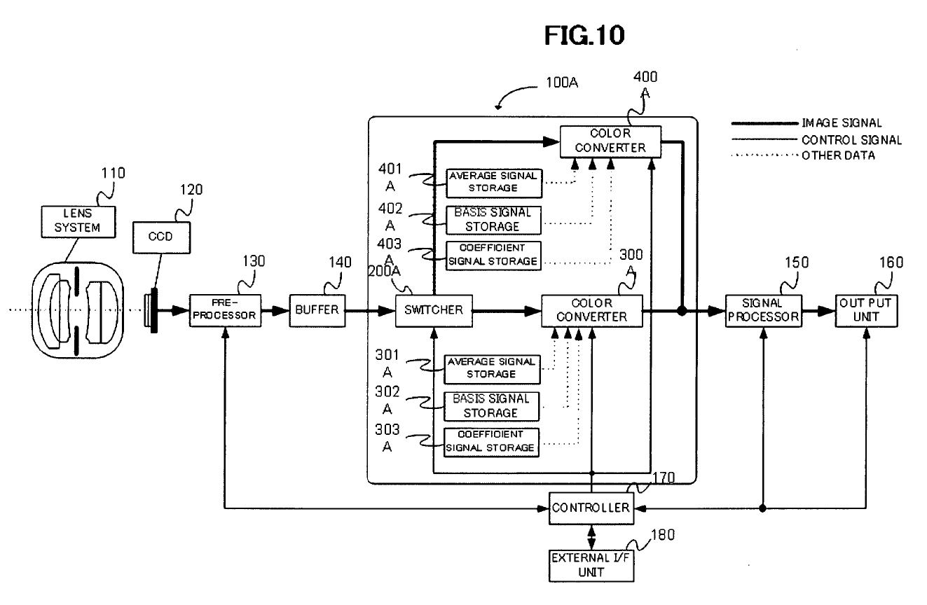

Next, still another embodiment of the present invention will be described with reference to FIG. 10. This embodiment is applied to a system that color-converts image data photographed with a digital camera and outputs the color-converted data, and is equipped with a single processor 100A.

In FIG. 10, parts having the same functions as reference numerals given in FIG. 8 are shown for avoiding a redundant description. A part with a reference character A added to its reference numeral has a similar signal to that reference numeral.

Data output from a buffer 140 are switched in a switcher 200A and are output to color converters 300A and 400A. The color converter 300A includes an average signal storage 301A, a basis signal storage 302A, and a coefficient signal storage 303A, while the color converter 400A includes an average signal storage 401A, a basis signal storage 402A, and a coefficient signal storage 403A.

The average signal storage 301A, basis signal storage 302A, coefficient signal storage 303A, average signal storage 401A, basis signal storage 402A, and coefficient signal storage 403A store a number of signals that corresponds to the kinds of output color signals after being color-converted. For example, when output color signals are L*, a*, and b* (L*a*b*), three signals are stored for L*, a*, and b*. Since the flow of other signals is the same as FIG. 8, a description of other signals will not be given.

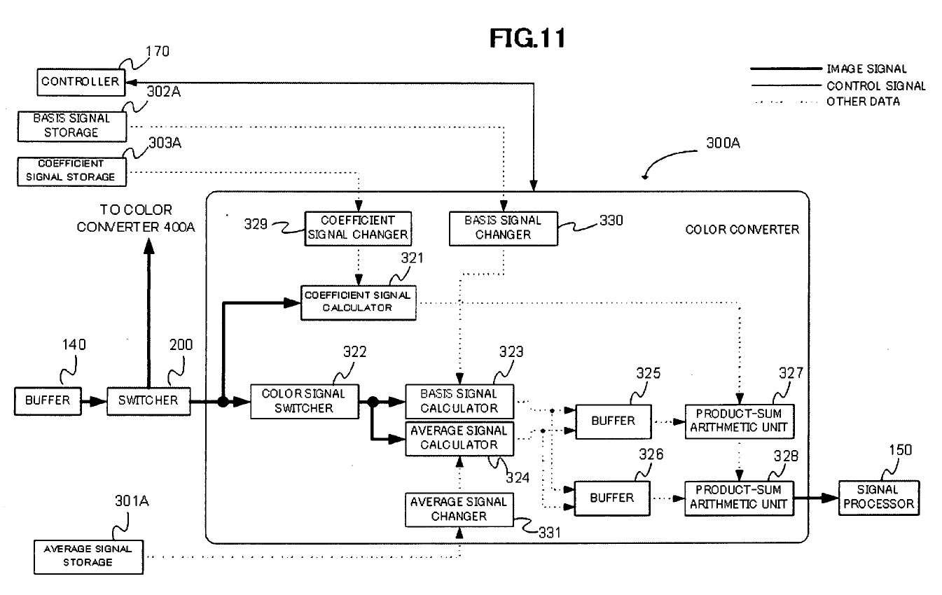

FIG. 11 is a block diagram showing a configuration of the color converter 300A in FIG. 10. In FIG. 11, blocks with the same signals as the blocks shown in FIG. 9 are given the same reference numerals in order to avoid a redundant description. The configuration of the color converter 400A is the same the color converter 300A, so it is not shown.

A coefficient signal changer 329, under control of a controller 170, changes a coefficient signal transferred from a coefficient signal storage 303A. For example, it can change a coefficient signal for an output value L* to a coefficient signal for an output value a*. A basis signal changer 330 changes a basis signal transferred from a basis signal storage 302A. For instance, it changes a basis signal for an output value L* to a basis signal for an output value a*. An average signal changer 331 changes an average signal transferred from an average signal storage 301A. For instance, it changes an average signal for an output value L* to an average signal for an output value a*. A color conversion process is omitted because it is the same as that shown in FIG. 9.

In FIG. 8, a plurality of processors are required in accordance with the kinds of color signals to be out put. However, employing the color converter 300A and color converter 400A, only one processor is required as shown in FIG. 10.

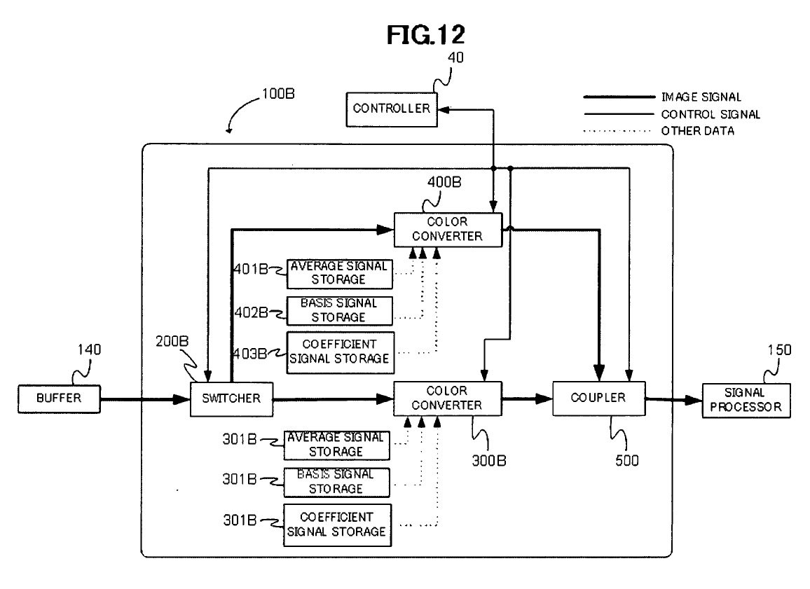

FIG. 12 shows a still further embodiment of the present invention and shows a configuration of the processor 100(1) in FIG. 8. The same blocks with the same signals as the blocks of FIG. 8 are given the same reference numerals, and reference characters B are added for avoiding a redundant description.

Data transferred from a buffer 140 are input to color converters 300B and 400B through a switcher 200B provided in a processor 100B.

The color converter 300B includes an average signal storage 301B, a basis signal storage 302B, and a coefficient signal storage 303B, while the color converter 400B includes an average signal storage 401B, a basis signal storage 402B, and a coefficient signal storage 403B.

The average signal storage 301B, basis signal storage 302B, coefficient signal storage 303B, average signal storage 401B, basis signal storage 402B, and coefficient signal storage 403B store a number of signals that corresponds to the kinds of output color signals after being color-converted.

The out puts of the color converter 300B and color converter 400B are connected to a coupler 500, in which a coupling process described later is executed.

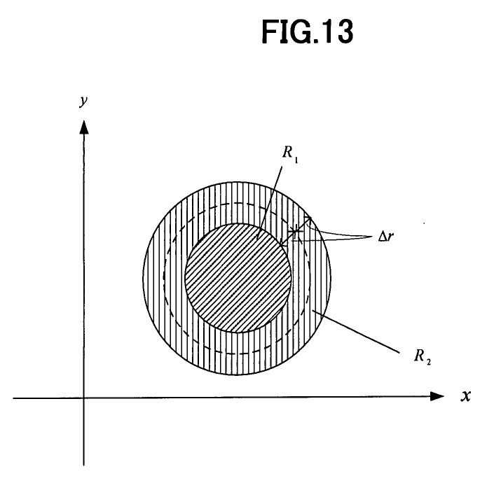

As shown in FIG. 13, when a color signal is contained in a range R1 of a specified color, the switcher 200B transfers an output color signal from the buffer 140, to the color converter 300B. When a color signal is present in a range of R2, the switcher 200B transfers the color signal to both the color converter 300B and the color converter 400B. When a color signal is present in a range other than R1 and R2, the switcher 200B transfers the color signal to the color converter 400B.

When a color signal is transferred from either the color converter 300B or the color converter 400B, the coupler 500 transfers the color signal as it is, to the signal processor 150. If color signals are transferred from both, the coupler 500 generates a new color signal by performing a coupling process on the color signal from the color converter 300B and the color signal from the color converter 400B, and transfers the generated signal to the signal processor 150.

FIG. 13 shows a two-dimensional space of xy, but this space may be any dimensions.

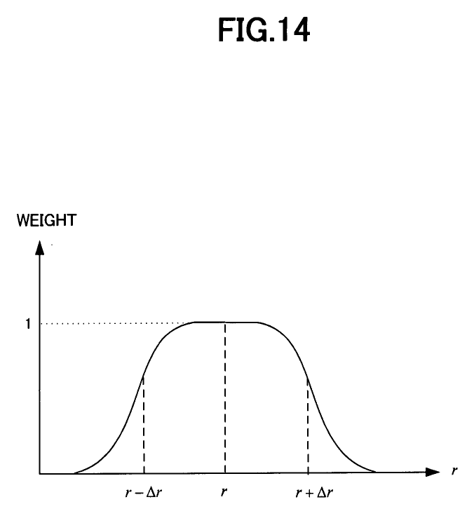

As an example of the coupling process, the following method is considered. In FIG. 13, a signal obtained in the color converter 300B is assumed to be (x₁,y₁), and a signal obtained in the color converter 400B is assumed to be (x₂,y₂). Assuming that a signal obtained as a result of the coupling process is (x′,y′), the coupling process is expressed by the following Eqs. 33 and 34:
x′=Wx₁+(1−W)x₂ (33)
x′=Wy₁+(1−W)y₂ (34)
in which W represents a weight coefficient and is given by the following relation:
W=w(x,y,S₁,S₂) (35)
For W ( ), various functions are considered. For example, a shape such as that shown in FIG. 14 is considered. As shown in FIG. 13, when a boundary between colors is expressed in a circle, the shape described above is expressed in one dimension, employing polar coordinate notation. In FIG. 14, Δr corresponds to Δr in FIG. 13. By this processing, the results of conversion at color boundaries can be smoothly joined together.

With the configuration described above, color conversion can be performed employing compressed LUT, whereby the storage capacity of a ROM is reduced and therefore costs can be made low. In the color conversion process, since average, basis, and coefficient signals can be changed, only one arithmetic circuit is required for color conversion and therefore costs can be made low.

As to the CCD in the embodiments described above, a single-plate CCD for a primary color system, and single-plate, two-plate, and three-plate CCDs for a complementary color system are considered. In the case of a single-plate CCD, the preprocessor 130 contains an interpolation process of single-plate to three-plate.

While the above embodiments are based on processing by hardware, the present invention does not need to be limited to such a configuration. For example, with a signal from the CCD 120 as raw data unprocessed, ISO sensitivity information, image size, and other information can be output as header information, and the header information can be processed by separate software.

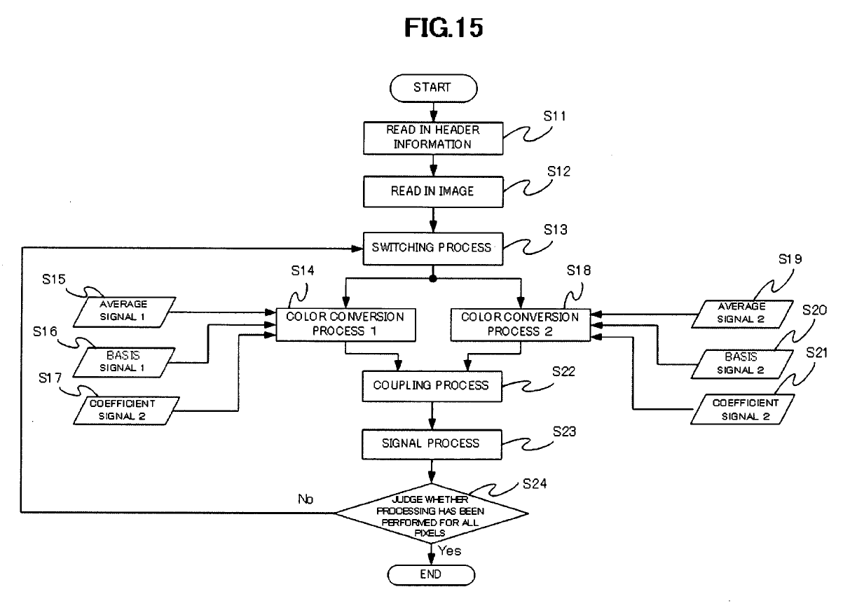

FIG. 15 is a flowchart showing the processing procedures that correspond to the second embodiment shown in FIG. 12. As to the color conversion process, the processing in FIG. 12 is shown. In step S11, header information, which contains information on ISO sensitivity and image size, is read in. In step S12, an image is read in. Next, in step S13 a switching process corresponding to the switcher 200B of FIG. 12 is performed, and a color signal is transferred to either a color conversion process 1 in step S14 or a color conversion process 2 in step S18. In step S15 an average signal 1 is read in; in step S16 a basis signal 1 is read in; in step S17 a coefficient signal 1 is read in; and these signals are transferred to step S14. In step S14 a color conversion process is performed in pixel units. This process corresponds to the processing in the color converter 300B of FIG. 12. In step S19 an average signal 2 is read in; in step S20 a basis signal 2 is read in; in step S21 a coefficient signal 2 is read in; and these signals are transferred to step S18. In step S18 a color conversion process is performed in pixel units. This process corresponds to the processing in the color converter 400B. In step S22 a coupling process corresponding to the coupler 500 of FIG. 12 is performed, and in step S23 a signal process, such as edge enhancement and gamut mapping, which corresponds to the signal processor 150 of FIG. 12 is performed. In step S24, it is judged whether processing has been performed for all pixels. When processing has not been performed, it is performed again from step S13 for each of unprocessed pixels. When processing has been performed on all pixels, the processing is ended.

As has been described hereinabove, the present invention is able to possess the following remarkable advantages. It should be noted that these advantages are mere examples. It is a mater of course that by referring to the embodiments described above, other advantages not listed can be obtained.

(1) Since LUT is compressed, the amount of data is reduced and therefore costs can be made low.

(2) A weighting process is performed on a specified color, and employing the weighting principal component analysis, LUT is compressed. Therefore, accuracy in regard to the specified color becomes higher.

(3) The number of basis signal after being compressed is changed, and the number of basis can be arbitrarily changed. Therefore, only the required number of basis can be transferred, so that the amount of data is reduced and costs can be made low.

(4) Since an input color space for LUT is converted and compressed, compressibility can be increased, or compression can be performed, taking a color difference into consideration.

(5) Instead of the weighting principal component analysis, one-variable signal groups are multiplied by a weighting signal, and the principal component analysis is performed on that data. Therefore, processing can be easily performed.

(6) An evaluation value is calculated for one-variable signal groups, and a basis signal is found so that the evaluation value is maximized. Therefore, the basis signal can be derived on the basis of the evaluation value.

(7) Since an evaluation value is obtained by performing a weighting process on an error of mean square, an error in regard to a specified color can be reduced.

(8) The weighting principal component analysis is performed with the above specified color as a flesh color, green, or sky, so stored colors of human beings can be compressed with high accuracy.

(9) By performing a statistical process on color information in an image, a color whose frequency is greatest is employed as a specified color. Therefore, the entire image can be compressed with high accuracy.

(10) By making smaller the weight of a color whose luminance value is a certain value or less, the accuracy of dark colors not so important to human beings is reduced, whereby the accuracy of bright colors is relatively increased.

(11) Since color conversion is performed employing information of LUT compressed, the storage capacity of a ROM becomes small and therefore costs can be made low.

(12) By coupling color signals output from two converters, the results of conversion from the two converters can be smoothly joined together. Therefore, colors can also be reproduced without a sense of incompatibility.

The configurations and operations of the preferred embodiments of the present invention have been described in detail. However, such embodiments are mere examples of the present invention, and are not to limit the present invention. It would be obvious to those skilled in this art that within the scope of the present invention, many modifications and variations are possible according to specified uses.

1-36. (canceled)

37. A compression apparatus for performing a compression process for a look-up table which performs a color conversion process corresponding to each of input color signals comprising color signal components of M kinds (where M is an integer of 2 or greater), comprising:
a variable fixer for fixing the other color signal components but one of said input color signals to calculate one-variable signal groups, the color conversion for the input color signal being expressed by signal groups;
a principal component analyzer for executing a principal component analysis for the one-variable signal groups obtained by the variable fixer to calculate a basis signal;
a storage unit for storing the coefficient obtained on the basis of the one-variable signal groups, an average signal of the one-variable signal groups and the basis signal; and
a controller for sending the coefficient stored in said storage unit to said principal component analyzer and causing said principal component analyzer to execute said principal component analysis.

38. The compression apparatus as set forth in claim 37, wherein weighting is performed on a specified color signal component included in said input color signals.

39. The compression apparatus as set forth in claim 38, wherein a color of said specified color signal component is a flesh color, green color, or sky color.

40. The compression apparatus as set forth in claim 39, wherein a color of said specified color signal component is a color whose frequency is greatest by a statistical process performed on an image.

41. The compression apparatus as set forth in claim 39, wherein a weight of a color whose luminance value is a certain value or less is set smaller than those of other colors.

42. The compression apparatus as set forth in claim 37, wherein said principal component analysis in said principal component analyzer determines said basis signal so that mean square between an addition of an average value of said signal groups and a cumulative sum of said basis signal multiplied by a coefficient and said signal groups, becomes a minimum;

43. The compression apparatus as set forth in claim 37, wherein a number of said basis signal in said principal component analysis is arbitrarily determined.

44. The compression apparatus as set forth in claim 38, wherein a number of said basis signal in said principal component analysis is arbitrarily determined.

45. The compression apparatus as set forth in claim 37, wherein said coefficient in said principal component analysis is determined based on said one-variable signal groups and said basis signal.

46. The compression apparatus as set forth in claim 37, further comprising a converter for converting a color space of said input color signals to a different color space.

47. The compression apparatus as set forth in claim 38, further comprising a converter for converting a color space of said input color signals to a different color space.

48. The compression apparatus as set forth in claim 37, further comprising a weighting function multiplier for multiplying a predetermined variable of said variable signal groups by a predetermined weighting function.

49. The compression apparatus as set forth in claim 38, further comprising a weighting function multiplier for multiplying a predetermined variable of said variable signal groups by a predetermined weighting signal.

50. A color converter for performing color conversion of input color signals comprising color signal component of M kinds (where M is an integer of 2 or greater), comprising:
a variable fixer for fixing the other color signal components but one of said input color signals to calculate one-variable signal groups, the color conversion for the input color signal being expressed by signal groups;
a principal component analyzer for executing a principal component analysis for the one-variable signal groups obtained by the variable fixer to calculate a basis signal; and
a color conversion processor for performing said color conversion process on the basis of information obtained by said principal component analyzer.

51. A color converter for performing color conversion of input color signals comprising color signal component of M kinds (where M is an integer of 2 or greater), comprising:
a weighting unit for weighting a specified color signal component included in said input color signals;
a variable fixer for fixing the other color signal but one of said input color signals to calculate one-variable signal groups, the color conversion for the input color signal being expressed by signal groups;
a first principal component analyzer for executing a principal component analysis for the specified color signal component of the one-variable signal groups obtained by the variable fixer to calculate a first basis signal;
a second principal component analyzer for executing a principal component analysis for the one-variable signal groups obtained by the variable fixer to calculate a second basis signal;
a first color conversion processor for performing said color conversion process for the specified color signal component on the basis of information including the first basis signal obtained by said first principal component analyzer; and
a second color conversion processor for performing said color conversion process for the specified color signal component on the basis of information including the second basis signal obtained by said second principal component analyzer.

52. The color converter as set forth in claim 51, wherein said first color conversion processor and second color conversion processor have a coupler for coupling conversion results of said two color conversion processors at a boundary and its periphery in a color space between a color of said specified color signal and the other colors.

53. The color converter as set forth in claim 52, wherein said coupler continuously couples said conversion results of said two color conversion processors.

54. A compressing method for performing a compression process for a look-up table which performs a color conversion process corresponding to each of input color signals comprising color signal components of M kinds (where M is an integer of 2 or greater), comprising:
fixing the other color signal components but one of said input color signals to calculate one-variable signal groups, the color conversion for the input color signal being expressed by signal groups,
executing a principal component analysis for the one-variable signal groups obtained by the variable fixer to calculate a basis signal, and
determining an average value of the one-variable signal groups, determining coefficient based on the one-variable signal groups, the average value and the basis signal, and executing the principal component analysis based on the coefficient.

55. The compression apparatus method as set forth in claim 54, wherein weighting is performed on a specified color signal component of said input color signals.

56. The compression apparatus method as set forth in claim 55, wherein a color of said specified color signal component is a flesh color, green color, or sky color.

57. The compression apparatus method as set forth in claim 55, wherein a color of said specified color signal component is a color whose frequency is greatest by a statistical process performed on an image.

58. The compression apparatus method as set forth in claim 55, wherein a weight of a color whose luminance value is a certain value or less is set smaller than those of other colors.

59. The compression apparatus method as set forth in claim 54, wherein said principal component analysis determines said basis signal so that an error of mean square between said addition value and said signal groups becomes a minimum.

60. The compression apparatus method as set forth in claim 54, wherein a number of said basis signal in said principal component analysis is arbitrarily determined.

61. The compression apparatus method as set forth in claim 55, wherein a number of said basis signal in said principal component analysis is arbitrarily determined.

62. The compression apparatus method as set forth in claim 54, wherein said coefficient in said principal component analysis is determined based on said one-variable signal groups and said basis signal.

63. The compression apparatus method as set forth in claim 54, wherein a color space of said input color signals is converted to a different color space.

64. The compression apparatus method as set forth in claim 55, wherein a color space of said input color signals is converted to a different color space.

65. The compression apparatus method as set forth in claim 54, wherein a predetermined variable of said variable signal groups is multiplied by a predetermined weighting function.

66. The compression apparatus method as set forth in claim 55, wherein a predetermined variable of said variable signal groups is multiplied by a predetermined weighting function.

67. A color conversion method of performing color conversion of input color signals of M kinds (where M is an integer of 2 or greater), comprising steps of:
a step of weighting a specified color signal component included in said input color signals, fixing the other color signal components but one of said input color signals to calculate one-variable signal groups, the color conversion for the input color signal being expressed by signal groups;
a step of executing a first principal component analysis for the specified color signal component of the one-variable signal groups obtained by the variable fixer to calculate a first basis signal;
a step of executing a second principal component analysis for the one-variable signal groups obtained by the variable fixer to calculate a second basis signal;
a step of performing said color conversion process for the specified color signal component on the basis of information obtained by said first principal component analyzer; and
a step of performing said color conversion process for the other color signal component than the specified color signal on the basis of information obtained by said second principal component analyzer.

68. The color conversion method as set forth in claim 67, wherein said first color conversion process and second color conversion process have a step of coupling conversion results of the first and second color conversion processes at a boundary and its periphery in a color space between a color of said specified color signal and the other colors.

69. The color conversion method as set forth in claim 68, wherein said conversion results of said two color conversion processors are continuously coupled together.

70. A program for causing a computer to execute the color conversion method as set forth in claim 54.

71. A program for causing a computer to execute the color conversion method as set forth in claim 66.

72. A storage medium with a program which causes a computer to execute the color conversion method as set forth in claim 70.

73. A storage medium with a program which causes a computer to execute the color conversion method as set forth in claim 71.
